(19) United States
(12) Patent Application Publication
(10) Pub. No.: US 2004/0240449 A1
(43) Pub. Date: Dec. 2, 2004

(54) Seamless support for internal and external packet data service with a single PDP connection in wireless communications devices

(76) Inventor: Li Su, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 10/445,600

(22) Filed: May 27, 2003

(51) Int. Cl. H04L 12/56

(52) U.S. Cl. 370/395.2

(57) ABSTRACT

A method in a communications device, for example, a Universal Mobile Telecommunications System (UMTS) W-CDMA mobile wireless communications device, including establishing (314) a packet data connection for the communications device, assigning (328) a packet address associated with the packet data connection to an external terminal upon detecting (320) that the external device is connected to the communications device, without disconnecting the packet data connection.

### FIELD OF THE DISCLOSURE

The present disclosure relates generally to data communications, and more particularly to establishing data services in subscriber devices, for example, establishing packet data service in an external terminal connected to a communications device having a packet data connection, apparatuses and methods therefor.

### BACKGROUND OF THE DISCLOSURE

Many communications devices, for example, Universal Mobile Telecommunications System (UMTS) based W-CDMA mobile wireless user equipment (UE), accommodate internal and external packet data services. Internal packet data service supports internal Web browsers, Java applications, File Transfer Protocol (FTP) applications, etc., running on the communications device. External packet data service supports similar services running on external terminal equipment, which is connected to the communications device. External terminal equipment includes, for example, a laptop personal computer (PC), or a personal digital assistant (PDA), or some other external device that communicates with the communications device or UE using a Point-to-Point Protocol (PPP) over a Bluetooth, or Infrared Data Association (IRDA) infrared, or Universal Serial Buss (USB), or RS232 connection, etc.

In applications where an external terminal, for example, a PC, is coupled to the UE, two Packet Data Protocol (PDP) connections are required if an Internet Protocol (IP) or other address is to be allocated to each of the internal and external packet data services. However, most wireless network operators provide only one “always on” PDP connection with a corresponding single IP address to support packet data service for each wireless mobile subscriber device or User Equipment (UE).

A single PDP connection is unable to support both external and internal packet data services simultaneously, since only one IP address is available. In applications where the UE is coupled to a PC or other external terminal equipment, presently, the user must manually de-activate internal packet service and disconnect the “always on” PDP connection in the UE. A new PDP connection is established upon establishing a Point-to-Point Protocol (PPP) connection between the UE and external terminal equipment, and then a new IP address is assigned to the external terminal equipment upon establishing the new PDP connection.

Manual de-activation of the internal packet service and disconnecting the “always on” PDP connection is generally inconvenient. Disconnecting and re-establishing a PDP connection, for example, requires some time, which delays the establishment of the packet data service in the external terminal. A new PDP connection also results in the assignrnent of a new IP address, which is different than the IP address associated with the “always on” packet data connection.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates an exemplary communications subscriber device connectable to an external terminal and to a packet data network.

FIG. 2 is an exemplary schematic block diagram of portions of a communications device and an external terminal.

FIG. 3 is an exemplary process diagram.

### DETAILED DESCRIPTION

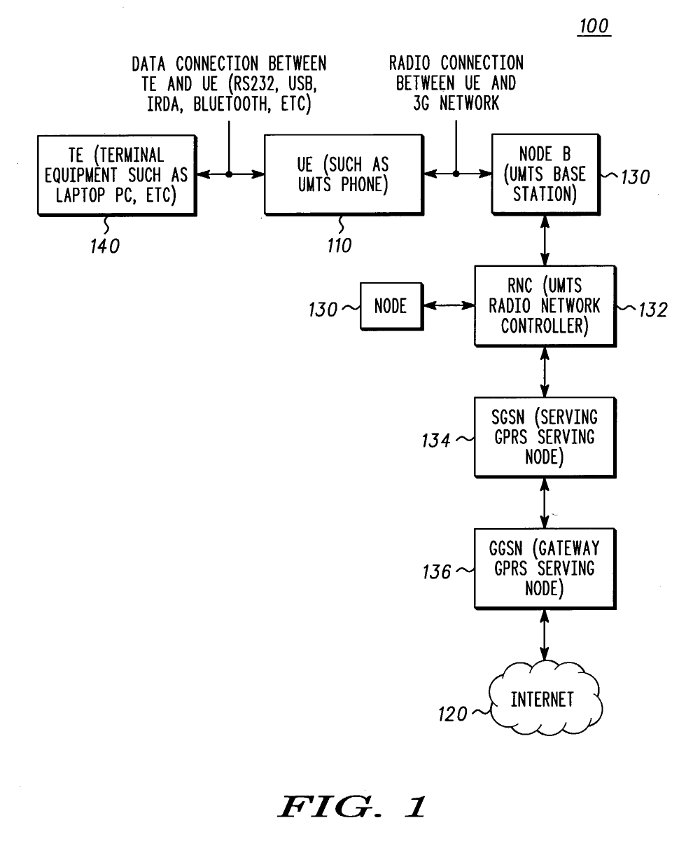

In the exemplary architecture 100 of FIG. 1, a communications device 110, for example, a Universal Mobile Telecommunications System (UMTS) W-CDMA mobile wireless communications device, is connectable to a data network, for example, the Internet 120, via an interconnecting UMTS wireless communications network. The exemplary wireless network includes a network of base station transceivers (Nodes) 130, communicably coupled to the Internet by a UMTS radio network controller (RNC) 132 and a Serving GPRS Serving (SGSN) 134 and a Gateway GPRS Serving Node (GGSN) 136, which is coupled to the data network. The disclosure is not limited to or by the exemplary UMTS network.

In FIG. 1, the communications device 110 is connectable to an external terminal 140, for example, a laptop personal computer (PC), or a personal digital assistant (PDA), or some other external packet data enabled device. The external terminal and communication device communicate pursuant to a data link connection over a hard-wired or wireless physical connection, for example, a Bluetooth, or Infrared Data Association (IRDA) infrared, or Universal Serial Bus (USB), or RS232 connection, etc. Exemplary data link protocols include, among others, the Point-to-Point Protocol (PPP), the Serial Line Internet Protocol (SLIP), IEEE 802.2 SNAP protocol, Ethernet II protocol, etc.

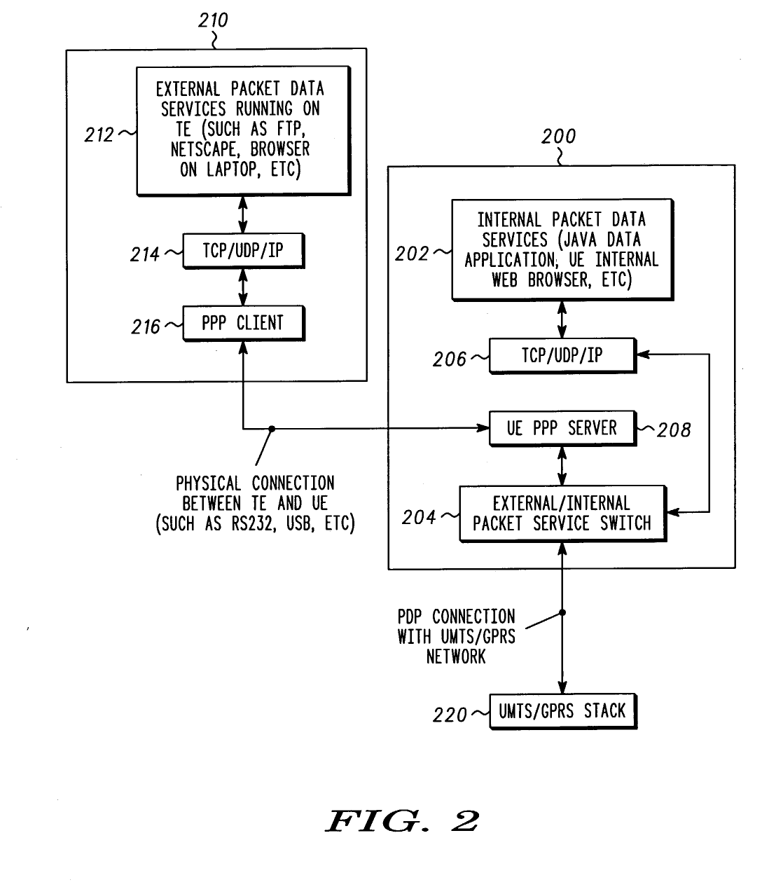

FIG. 2 is a more detailed illustration of a communications device 200 coupled to an external terminal 210. The exemplary communications device 200 includes an “always on” packet data connection, which is commonly provided by many wireless packet data services providers. In other embodiments, the packet data connection is not “always on”. The packet data connection has associated therewith at least one packet data address, for example, an Internet protocol (IP) address or some other packet address. In some embodiments including, for example, the “always on” packet connection, not more than one packet address is associated with the packet connection.

In FIG. 2, the exemplary communications device or subscriber terminal 200 includes an internal packet service entity 202, for example, a browser, Java data, etc. suitable for use in the communications device. The packet service entity 202 is coupled to an internal packet service switch 204 by a packet data protocol entity, for example, a Transport Control Protocol (TCP)/User Datagram Protocol (UDP)/Internet Protocol (IP) entity 206, which makes the Packet Data Protocol (PDP) connection with a UMTS/GPRS stack entity 220 in the network.

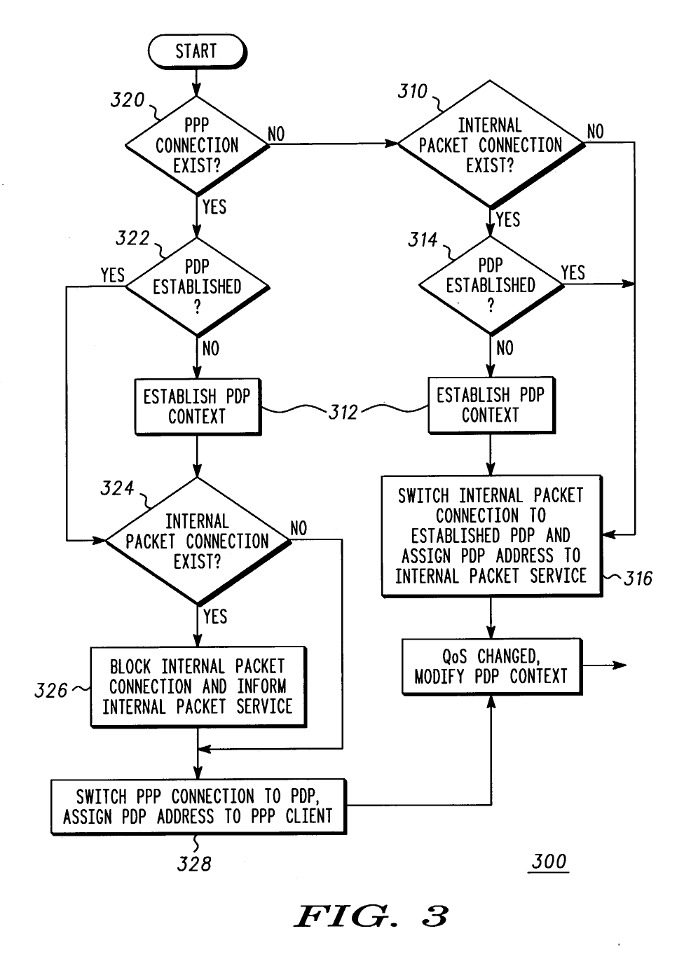

In the process diagram 300 of FIG. 3, at block 310, if there is an internal packet connection, for example, if the internal packet service 202 is enabled or activated by the switch 204 in FIG. 2, packet data service is established at block 312, if a determination is made at block 314 that there is no packet data service. Upon establishing packet data service at block 312, if there was no prior service, for example, upon powering-on a device where packet service is “always on”, a packet address associated with the packet connection is allocated or assigned to the internal packet service 202 at block 316. The functionality discussed above in connection with blocks 310, 312, 314 and 316 is performed on the communications device, for example, by a software algorithm or by a processor executable program stored in memory or on some other computer readable or medium of the device.

In FIG. 3, at block 320, a determination is made at the communications device whether a data link connection, for example, a PPP connection, with an external terminal has been detected. In FIG. 2, the exemplary external terminal 210 includes an external packet service entity 212 coupled to a TCP/UDP/IP entity 214 coupled to a Point-to-Point protocol (PPP) client 216, which makes a data link connection with a PPP server 208 on the communications device 200 via the physical connection, examples of which were discussed above.

In FIG. 3, if a data link connection has been established at block 320, in some embodiments, the communications device determines at block 322 whether a packet data connection exits. At block 312, a packet data connection is established if a determination is made at block 322 that a PDP connection does not exist. If the internal packet service is connected at block 324, the internal packet service is disabled at block 326. In FIG. 2, for example, upon detecting the establishment of the PPP connection with the external terminal, the switch 204 in the communications device 200 disables or de-activates the internal packet service 202 if the service is connected or enabled. In some embodiments, for example, disabling of the internal packet service occurs upon detecting in the communications device that a data link connection has been established with the external terminal. The switch 204 also connects the PPP server entity 208 to the UMTS/GPRS stack entity 220 in the network.

Generally, the packet address associated with the packet data connection is allocated or assigned to the external terminal upon establishing the data link between the communications device and the external terminal without interrupting the packet data connection. In FIG. 3, for example, at block 328, the packet address is assigned to the PPP client 216 running on the external terminal without interrupting the packet data connection. If the packet address was previously allocated to the internal packet service, the address is re-allocated to the external packet service. In FIG. 2, the packet service switch 204 connects the PPP server entity 208 to the UMTS/GPRS stack entity 220 in the network and disconnects the TCP/UDP/IP entity 206 from the UMTS/GPRS stack entity 220 if it was previously connected. Similarly, when the packet service switch 204 connects the TCP/UDP/IP entity 206 to the UMTS/GPRS stack entity 220, the PPP server entity 208 is disconnected from the UMTS/GPRS stack entity 220 if it was previously connected, as discussed further below.

The packet data service on the communications device is preferably de-activated automatically upon establishing the data link connection between the communications device and the external terminal, and the packet address associated with the packet data connection is automatically allocated to the external terminal by re-allocating the packet address if it was preciously allocated to the communications device without interrupting the packet data connection.

The functionality discussed above in connection with blocks 320, 322 and 328 is performed on the communications device, for example, by a software algorithm or by a digital processor executable program stored in memory or on some other computer readable or medium of the device. The program thus includes a program segment that establishes a packet data connection with the communications device, and another program segment the assigns the packet address associated with the packet data connection to an external terminal upon detecting that the external terminal is connected to the communications device without disconnecting the packet data connection.

The exemplary computer program stored on the computer readable medium of the communications device also preferably includes a program segment that disables packet service in the communications device upon detecting that the external terminal is connected to the communications device. Generally, the computer program also includes a program segment that allocates the packet address of the packet data connection to the communications device upon initially establishing the packet data connection with the communications device, and a program segment that re-allocates the packet address of the packet data connection to the external terminal upon connecting the external terminal with the communications device without disconnecting the packet data connection.

In FIG. 2, the packet data switch 204 also disconnects the PPP server 208 from the UMTS/GPRS stack entity 220 of the network and connects the TCP/UDP/IP entity 206 to the UMTS/GPRS stack entity 220 upon detecting that the external device has been disconnected from the network, for example, upon detecting that the data link established by the PPP client has been disabled. The exemplary program also includes a program segment for performing this functionality.

While the present disclosure and what are considered presently to be the best modes of the inventions have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in a communications device, comprising:
establishing a packet data connection for the communications device;
assigning a packet address associated with the packet data connection to an external terminal upon detecting that the external device is connected to the communications device,
the packet address associated with the packet data connection assigned to an external terminal without disconnecting the packet data connection.

2. The method of claim 1,
assigning the packet address associated with the packet data connection to the communications device upon establishing the packet data connection for the communications device,
assigning the packet address to the external terminal by re-assigning the packet address assigned to the communications device without disconnecting the packet data connection.

3. The method of claim 2,
disabling packet service on the communications device upon detecting that the external terminal is connected to the communications device.

4. The method of claim 1,
deactivating packet service on the communications device upon detecting that the external terminal has established a data link with the communications device.

5. The method of claim 1, automatically assigning the packet address associated with the packet data connection to the external terminal upon detecting that the external terminal is connected to the communications device without disconnecting the packet data connection.

6. The method of claim 1,
the packet data connection having not more than one packet address associated therewith,
assigning the not more than one packet address associated with the packet data connection to an external terminal, without disconnecting the packet data connection, upon detecting that the external device is connected to the communications device.

7. The method of claim 1, establishing the packet data connection for the communications device by establishing an “always on” packet data connection having not more than one packet address.

8. The method of claim 7, reassigning the packet address associated with the packet data connection to the communications device upon detecting that the external device is disconnected from the communications device without disconnecting the “always on” packet data connection.

9. The method of claim 1, reassigning the packet address associated with the packet data connection to the communications device upon detecting that the external device is disconnected from the communications device without disconnecting the packet data connection.

10. A communications device having a computer program stored on a computer readable medium, comprising:
a program segment that establishes a packet data connection with the communications device;
a program segment the assigns a packet address associated with the packet data connection to an external terminal upon detecting that the external terminal is connected to the communications device,
the packet address associated with the packet data connection is assigned to the external device without disconnecting the packet data connection previously established with the communications device.

11. The communications device having the computer program stored on the computer readable medium of claim 10,
a program segment that disables packet service in the communications device upon detecting that the external terminal is connected to the communications device.

12. The communications device having the computer program stored on the computer readable medium of claim 10,
a program segment that allocates the packet address of the packet data connection to the communications device upon establishing the packet data connection with the communications device;
a program segment that re-allocates the packet address of the packet data connection to the external terminal upon connecting the external terminal with the communications device without disconnecting the packet data connection.

13. A method in a communications device communicably coupled to an external terminal, the method comprising:
establishing a packet data connection having a packet address associated therewith for the communications device;
establishing a data link connection between the communications device and the external terminal;
allocating the packet address associated with the packet data connection to the external terminal upon establishing the data link between the communications device and the external terminal without interrupting the packet data connection.

14. The method of claim 13, automatically de-activating packet data service on the communications device upon establishing the data link connection between the communications device and the external terminal.

15. The method of claim 13,
allocating the packet address associated with the packet data connection to the communications device,
allocating the packet address associated with the packet data connection to the external terminal by re-allocating the packet address allocated to the communications device upon establishing the data link between the communications device and the external terminal without interrupting the packet data connection.

16. The method of claim 15, de-activating packet data service on the communications device upon establishing the data link connection between the communications device and the external terminal.

17. The method of claim 13, re-allocating the packet address associated with the packet data connection to the communications device when the data link between the communications device and the external terminal no longer exists without interrupting the packet data connection.
